(19) United States
(12) Patent Application Publication
(10) Pub. No.: US 2025/0153520 A1
(43) Pub. Date: May 15, 2025

(54) STEP DETECTION DEVICE

(71) Applicant: HITACHI ASTEMO, LTD., Hitachinaka-shi, Ibaraki (JP)

(72) Inventors: Takeo HOSOKAWA, Hitachinaka-shi, Ibaraki (JP); Fumio YUKI, Hitachinaka-shi, Ibaraki (JP); Atsuo SOMA, Hitachinaka-shi, Ibaraki (JP)

(73) Assignee: HITACHI ASTEMO, LTD., Hitachinaka-shi, Ibaraki (JP)

(21) Appl. No.: 18/834,060

(22) PCT Filed: Apr. 6, 2022
(86) PCT No.: PCT/JP2022/017157

§ 371 Date: Jul. 29, 2024

(51) Int. Cl. B60C 23/06; G01L 1/22; G01L 5/00

(52) U.S. Cl. CPC B60C 23/064; G01L 1/2268; G01L 5/0052

(57) ABSTRACT

An object of the present invention is to obtain a step detection device that can accurately detect a step without being affected by weather, environmental conditions, and the like. A step detection device (2) according to the present invention is a step detection device 2 that detects a step (20) in a case where a tire (10) of a vehicle (100) runs over the step, including: a plurality of strain detection elements (1) disposed on a tire inner circumferential surface of the tire at predetermined intervals in a circumferential direction of the tire; and a signal processor (4) that processes detection signals of the plurality of strain detection elements. The signal processor detects the step based on detection signals of two or more adjacent strain detection elements among the plurality of strain detection elements.

### TECHNICAL FIELD

The present invention relates to a step detection device.

### BACKGROUND ART

A vehicle may need to pass over a step during usual traveling or may unintentionally run over a step. In such a case, the vehicle temporarily receives resistance from the step. Therefore, in a case where the vehicle is operated by a human, the driver depresses an accelerator pedal a little more than in usual traveling. In a case where the step is small, the driver can pass over the step without discomfort. However, in a case where the step is large, the driver depresses the accelerator pedal more to increase the torque and run over the step. In this case, since the resistance due to the step immediately decreases, the vehicle's behavior suddenly changes, and an occupant may feel uneasy. Therefore, there is room for examination of control performance of an accelerator, a brake system, and the like in order to safely pass over or run over a step with a smooth operation without discomfort.

In addition, in a case where a driver is in a situation in which a step such as a car stop is blocked by a vehicle body, the driver may perform a series of operations without noticing the step, and there is also a risk of suddenly approaching nearby objects due to unintended sudden acceleration, and thus it cannot be said that the operation is safe and secure.

In recent years, PTL 1 has disclosed a step detection method for providing a safer traveling state toward realization of automatic driving. PTL 1 describes that, to address the problem that “in a case where the size or rigidity of a tire mounted on an axle differs, the relationship between a load acting on the tire and a tire air pressure differs, and thus there is a possibility that the control for the tire to pass over the step cannot be appropriately performed in a case where a tire air pressure is used,” a system that is provided with: a state detection device; and a camera or the like attached to a side mirror disposed closer to the rear of the vehicle than a center of a driving tire so that it is possible to take an image of the driving tire is constituted in order to more appropriately perform the control for the tire to pass over the step, and it is possible to more appropriately perform the control for the tire to pass over the step. That is, the information obtained from the camera or the like is analyzed to perform the control for passing over the step.

Meanwhile, a technique for detecting strain of a vehicle tire is known. For example, a strain sensor of a tire can detect a load or the like acting on the tire by detecting deformation of the tire. In addition, since the strain sensor is mounted on an inner surface of the tire, its robustness against weather and environmental changes is high. Accordingly, it is expected to improve traveling safety by preventing vehicle troubles in advance and detecting traveling and road surface states.

### CITATION LIST

### Patent Literature

PTL 1: JP 2020-142697 A

### SUMMARY OF INVENTION

### Technical Problem

In PTL 1, in the detection by the camera or the like, there is a concern that the detection performance may be affected by weather and environmental changes, especially water and mud splashing during traveling, and may thus be degraded. In addition, in the detection method of the related art using one strain sensor, the road surface detection section is limited, and thus there is a problem in that the measurement cannot be performed unless a step and a sensor match in use for detection of the step or the like.

An object of the present invention is to provide a step detection device that can accurately detect a step without being affected by weather, environmental conditions, and the like.

### Solution to Problem

The present invention has been contrived in view of the above problems, and adopts the configuration described in the claims, for example.

A step detection device according to the present invention is a step detection device that detects a step in a case where a tire of a vehicle runs over the step, including: a plurality of strain detection elements disposed on a tire inner circumferential surface of the tire at predetermined intervals in a circumferential direction of the tire; and a signal processor that processes detection signals of the plurality of strain detection elements, in which the signal processor detects the step based on detection signals of two or more adjacent strain detection elements among the plurality of strain detection elements.

### Advantageous Effects of Invention

According to the present invention, it is possible to provide a step detection device that can detect a step without being affected by weather, environmental changes, and the like. Problems, configurations, operations, and effects of the present invention other than those described above will be clarified by the following description of examples.

### BRIEF DESCRIPTION OF DRAWINGS

FIG. 1 is a block diagram showing a schematic configuration of a vehicle with a step detection device of the present embodiment mounted thereon.

FIG. 2 shows schematic diagrams showing a state in which a tire having a plurality of strain sensors 1-1 rolls on a road surface as a vehicle travels. FIG. 2(1) shows a state in which no step is present in a tire traveling direction, and FIG. 2(2) shows a state in which a step is present in the tire traveling direction and the tire contacts the step.

FIG. 3 is an explanatory diagram showing a sensor signal waveform of a strain sensor 1-1 according to a rotation state of a tire.

FIG. 4A shows a schematic diagram showing a state in which the tire contacts the step at a position between a part of the tire where the strain sensor 1-1 is disposed and a part of the tire where a strain sensor 1-4 is disposed, and schematic diagrams showing an example showing an output signal of the strain sensor and a differential value of the output signal in that state.

FIG. 4B shows a schematic diagram showing a state in which the part where the strain sensor 1-1 is disposed contacts the step, and schematic diagrams showing an example of an output signal of the strain sensor 1-1 and a differential value of the output signal in that state.

FIG. 4C shows a schematic diagram showing a state in which the tire contacts the step at a position between the part of the tire where the strain sensor 1-1 is disposed and a part of the tire where a strain sensor 1-2 is disposed, and schematic diagrams showing an example of an output signal of the strain sensor 1-1 and a differential value of the output signal in that state.

FIG. 5 is a diagram explaining a configuration of a signal processor.

FIG. 6 shows graphs showing a differential value of an output signal of each strain sensor with respect to an angular position of the tire.

FIG. 7 is a block diagram explaining a configuration of a threshold determination unit.

FIG. 8 is a block diagram associated with threshold determination, showing an example of an operation for an erroneous step detection prevention method.

FIG. 9 shows determination graphs showing an example of an operation by the step detection device according to the present embodiment, in which FIG. 9(1) is a graph showing a change in the differential value before smoothing processing, and FIG. 9(2) is a graph showing a change in the differential value after smoothing processing.

FIG. 10A shows a schematic diagram showing a state in which the tire contacts the step at a position where the strain sensor 1-1 is positioned above the step, and schematic diagrams showing an example showing an output signal of the strain sensor 1-1 and a determination result in that state.

FIG. 10B shows a schematic diagram showing a state in which the part of the tire where the strain sensor 1-1 is disposed contacts the step, and schematic diagrams showing an example of an output signal of the strain sensor 1-1 and a determination result in that state.

FIG. 10C shows a schematic diagram showing a state in which the tire is grounded on the road surface at a position where the strain sensor 1-1 is positioned below the step, and schematic diagrams showing an example of an output signal of the strain sensor 1-1 and a determination result in that state.

FIG. 11 shows a state in which the tire contacts the step, operation content of a determination circuit in the above state, and a determination graph of differential values of the strain sensors.

FIG. 12 shows a state in which the tire treads on gravel or the like, operation content of the determination circuit in the above state, and a determination graph of differential values of the strain sensors.

FIG. 13 is a block diagram showing an example of a method of setting a threshold used for determination of the step.

FIG. 14 shows time charts showing an example of changes in the output signal and the differential value when the tire contacts the step as in the state shown in FIG. 4A(1).

FIG. 15 shows time charts showing an example of changes in the output signal and the differential value when the tire contacts the step as in the state shown in FIG. 4B(2).

FIG. 16 is a plan view of a strain detection module.

FIG. 17 is a cross-sectional view along line A-A in FIG. 16.

### DESCRIPTION OF EMBODIMENTS

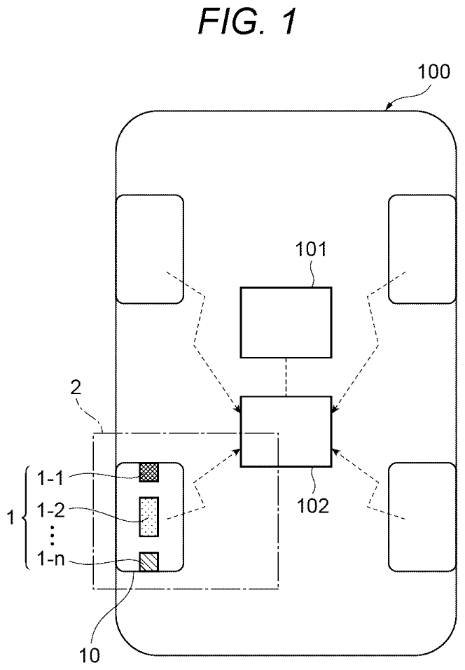

Hereinafter, embodiments of the present invention will be described in detail with reference to FIGS. 1 to 11.

A step detection device 2 of the present embodiment is for improving control performance of an accelerator, a brake system, and the like for safe and secure vehicle operation, especially for improving the accuracy of automatic driving, and is applied to an automatic driving vehicle having an automatic driving function.

In all the drawings for describing the embodiments, the same members are denoted by the same reference numerals in principle, and repeated description thereof will be omitted. In each of the cross-sectional view, the front view, and the side view, directions are specified by XYZ axes orthogonal to each other. +X is defined as “right,”−X is defined as “left,” +Y is defined as “up,”−Y is defined as “down,” +Z is defined as “front,” and −Z is defined as “rear.”

The present invention is not interpreted to be limited to the description of the embodiments described below. Those skilled in the art will readily understand that the specific configuration can be changed without departing from the spirit or gist of the present invention.

FIG. 1 is a block diagram showing a schematic configuration of a vehicle with the step detection device of the present embodiment mounted thereon.

As shown in FIG. 1, a vehicle 100 includes four tires 10, a control unit 101, and a receiver 102, and includes a plurality of strain sensors 1 (1-1, 1-2, . . . , and 1-n) on the tires 10. The vehicle 100 is not limited to the four-wheeled vehicle as shown in FIG. 1 that travels on a road surface 30, and may be applied to a two-wheeled vehicle, or a vehicle with a plurality of tires mounted thereon such as a truck or a bus. In addition, the present embodiment shows a configuration in which all the tires 10 have the plurality of strain sensors 1, but one or more tires 10 may have the plurality of strain sensors 1.

The control unit 101 is formed of an electronic control unit (ECU), and has hardware including a central processing unit (CPU), a memory such as a ROM and a RAM, and an input/output interface. The memory stores a software program for performing various arithmetic processing in an executable state. The control unit 101 executes a software program by the hardware to implement functions of a signal processor 4 and the like to be described later. The receiver 102 receives signals detected by the plurality of strain sensors 1 by wireless communication, and supplies the signals to the control unit 101 as output signals of the strain sensors 1. The step detection device 2 of the present embodiment is formed of partial functions of each strain sensor 1 and the control unit 101. The control unit 101 may also have a configuration for performing vehicle control based on the step detection in addition to the step detection processing.

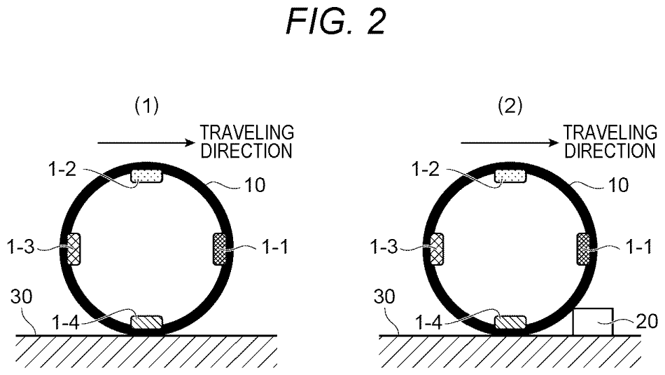

FIG. 2 shows schematic diagrams showing a state in which a tire having a plurality of strain sensors rolls on a road surface as a vehicle travels. FIG. 2(1) shows a state in which no step is present in a tire traveling direction, and FIG. 2(2) shows a state in which a step is present in the tire traveling direction and the tire contacts the step. A step 20 has such a height that the tire 10 can run over it.

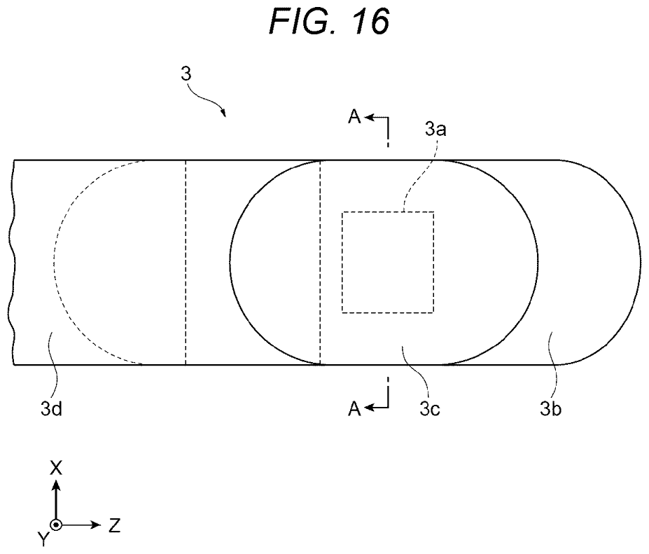

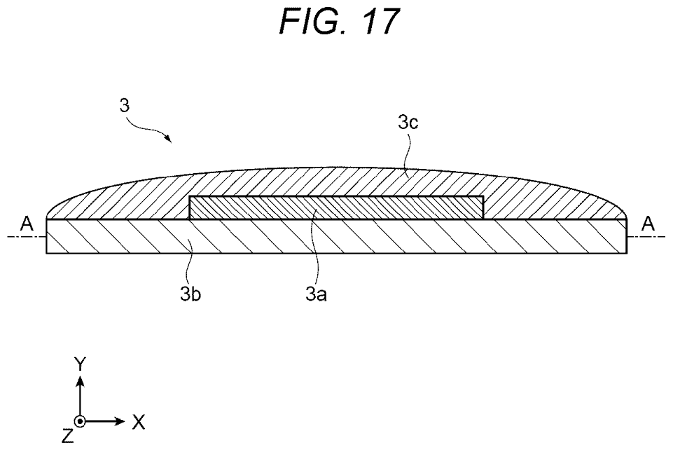

Each strain sensor 1 of the present embodiment includes a strain detection element 3a (see FIGS. 16 and 17), is mounted, for example, inside the tire 10 of the vehicle, and detects strain of the tire 10. Each strain sensor 1 is fixed to an inner surface (hereinafter, referred to as a tire inner circumferential surface) of a tread part of the tire 10, and detects, as strain, deformation in a compression direction and a tensile direction that is generated on the tire inner circumferential surface. In the present embodiment, the tire 10 is a tubeless tire assembled to a wheel (not shown) in which a sealed space formed between the wheel and the tire is filled with a high-pressure gas.

The plurality of strain sensors 1 are disposed at predetermined intervals in a circumferential direction of the tire 10. In the present embodiment, as shown in FIG. 2, a total of four strain sensors 1 (1-1, 1-2, 1-3, and 1-4) are disposed at intervals of 90 degrees. The number of strain sensors 1 and the interval between the strain sensors 1 adjacent to each other can be set according to the detection performance of the strain sensors 1.

In the situation shown in FIG. 2(1), no step is present on the road surface 30, and a part of the tire 10 where the strain sensor 1-4 is disposed is grounded on the road surface 30. In this situation, the strain sensor 1-4 detects a strain amount corresponding to the deformation of the tire 10.

In addition, in the situation shown in FIG. 2(2), the step 20 is present on the road surface 30, and the tire 10 is grounded on the road surface 30 and contacts the step 20. In the tire 10, the part of the tire 10 where the strain sensor 1-4 is disposed is grounded on the road surface 30, and a part positioned between the strain sensors 1-1 and 1-4 contacts the step 20. In this case, the two strain sensors 1-1 and 1-4 adjacent to the road surface 30 and the step 20 detect a strain amount corresponding to the deformation of the tire 10. That is, the step 20 is detected based on detection signals of the adjacent strain sensors 1-1 and 1-4.

Here, the schematic diagram in which four strain sensors 1 are mounted is used, but a configuration in which a plurality of strain sensors are mounted to detect the step 20 may be adopted. The sensor numbers may not be arranged in the order of 1-1 to 1-4, and may be a combination of other numbers.

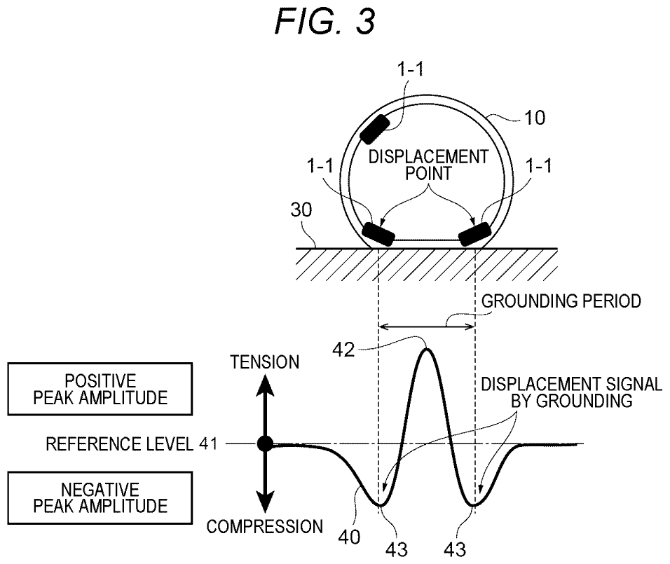

Next, a sensor signal waveform 40 in a case where one strain sensor 1-1 is used will be described with reference to FIG. 3.

FIG. 3 is an explanatory diagram showing a sensor signal waveform 40 of the strain sensor 1-1 according to a rotation state of the tire 10. As shown in FIG. 3, the strain sensors 1 disposed in the tire 10 output a sensor signal waveform 40 that changes according to the state of the rotating tire 10 with respect to the road surface. The strain sensor 1-1 outputs the sensor signal waveform 40 having a reference level 41, a positive level changing to a more positive side than the reference level 41, and a negative level changing to a more negative side than the reference level 41.

The strain sensor 1-1 maintains the reference level (steady-state value) 41 of the sensor signal waveform 40 when the part of the tire 10 where the strain sensor 1-1 is disposed is not grounded on and does not contact the road surface 30 or the step 20. The strain sensor 1-1 outputs a peak value (maximum value) 42 of the positive level of the sensor signal waveform 40 in a state in which the part of the tire 10 where the strain sensor 1-1 is disposed is grounded on the road surface 30. In addition, the strain sensor 1-1 outputs a peak value 43 of the negative level of the sensor signal waveform 40 at a moment at which the part of the tire 10 where the strain sensor 1-1 is disposed is grounded on or separated from the road surface 30.

Here, the moment at which the part of the tire 10 where the strain sensor 1-1 is disposed is grounded on or separated from the road surface 30 is represented by a sensor displacement point (peak value 43). A ground period in which the part of the tire 10 where the strain sensor 1-1 is disposed is grounded on the road surface 30 is between two sensor displacement points (peak values 43). The sensor signal waveform 40 detected as above changes according to various physical quantities (load amount, air pressure, speed, temperature, and the like).

Here, the moment at which the part of the tire 10 where the strain sensor 1-1 is disposed is grounded on or separated from the road surface 30 is defined as negative (compression), and the state in which the part of the tire 10 where the strain sensor 1-1 is disposed is grounded on the road surface 30 is defined as positive (tension). However, the same can be considered even in a case where the positive and the negative are reversed depending on the mounting direction of the strain sensor 1-1 on the tire inner circumferential surface. As above, the strain sensors 1 are mounted on the tire inner circumferential surface of the tire 10, and measure a strain amount according to the deformation of the tire 10.

For example, in the step detection by suspension control in the related art, a method using information obtained by detecting a road surface state using a laser sensor has been considered, but there has been a concern that detection failure may occur in the laser sensor due to weather, sunlight conditions, and the like. In particular, it is presumed that necessary measures are required for detection failure in a case where the lens is contaminated by water, mud splashing, and the like.

Meanwhile, the strain sensor 1 is mounted on the tire inner circumferential surface, and thus can detect a step without being affected by weather. In addition, since the step is determined from the deformation occurring due to the direct contact between the step 20 and the tire 10, the step detection can be performed regardless of the posture of the vehicle even when parked on an inclined surface such as a slope where the laser sensor performs poorly. Therefore, in contrast to using the laser sensor used for the step detection by suspension control in the related art, in the present embodiment, the strain sensors 1 are used, and thus it is possible to perform the step detection with high environmental robustness.

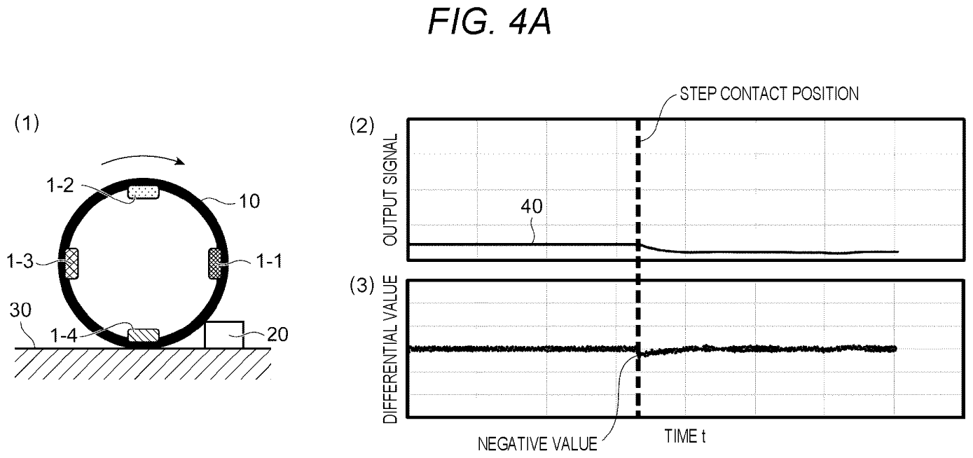

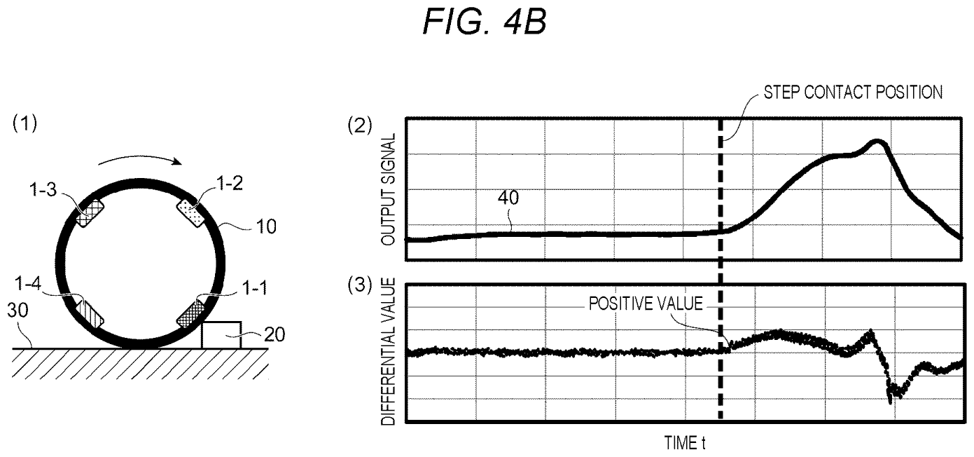

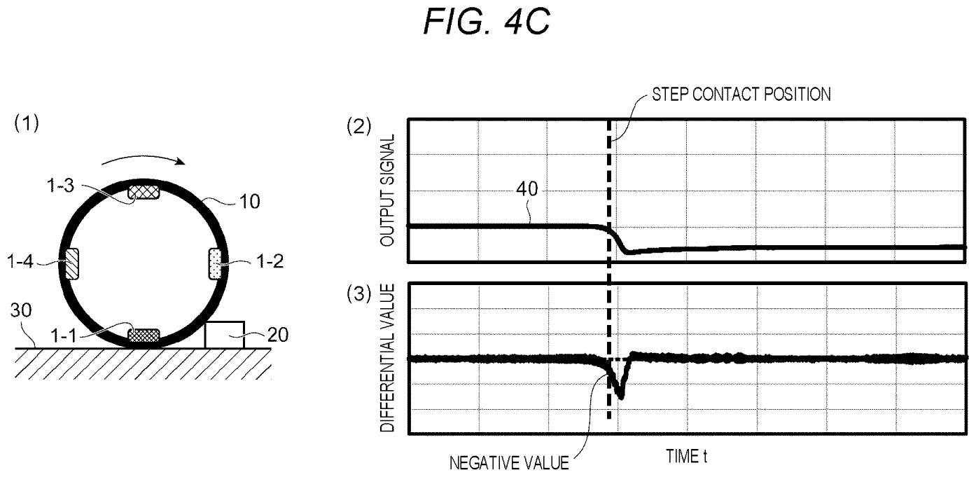

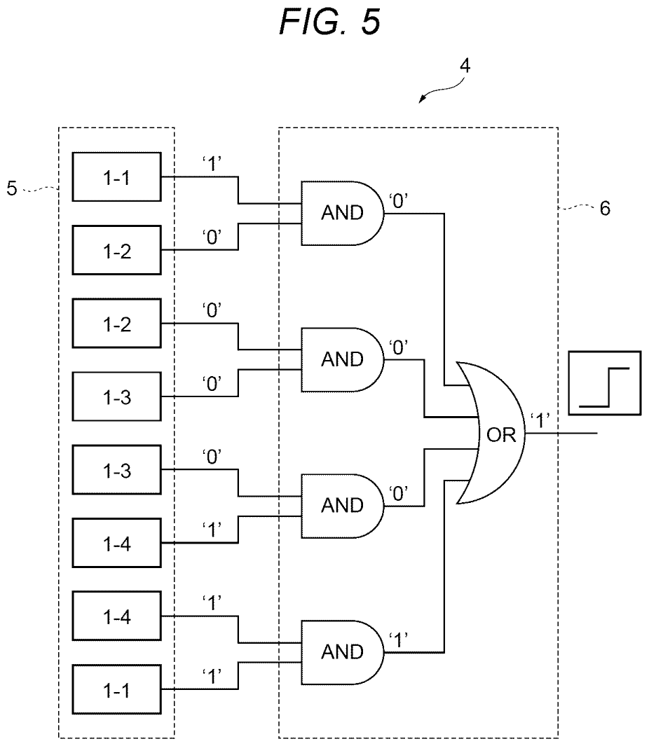

Next, an output signal and a differential value waveform at the time of contact with a step at the position of each of the strain sensors 1-1 to 1-4 will be described with reference to FIGS. 4A, 4B, 4C, and 5.

FIG. 4A(1) shows a state in which the part of the tire 10 where the strain sensor 1-1 is disposed is positioned above the step 20, the part of the tire 10 where the strain sensor 1-4 is disposed is grounded on the road surface 30, and the tire 10 contacts the step 20 at a position between the part of the tire 10 where the strain sensor 1-1 is disposed and the part of the tire 10 where the strain sensor 1-4 is disposed. In this case, when the force acting from the step 20 deforms the tire 10, the strain sensor 1-1 receives the force in the compression direction, leading to a change to a more negative side than the reference level 41. Therefore, as shown in FIGS. 4A(2) and 4A(3), the sensor signal waveform 40 of the sensor output signal at the step contact position where the tire 10 contacts the step 20 decreases, and its differential value becomes a negative value.

FIG. 4B(1) shows a state in which the part of the tire 10 where the strain sensor 1-1 is disposed contacts the step 20. In this case, when the force acting from the step 20 deforms the tire 10, the strain sensor 1-1 receives the force in the tension direction, leading to a change to a more positive side than the reference level 41. Therefore, as shown in FIGS. 4B(2) and 4B(3), the sensor signal waveform 40 of the sensor output signal at the step contact position increases, and its differential value becomes a positive value.

FIG. 4C(1) shows a state in which the part of the tire 10 where the strain sensor 1-1 is disposed is positioned below the step 20 and grounded on the road surface 30, the part of the tire 10 where the strain sensor 1-2 is disposed is positioned above the step 20, and the tire 10 contacts the step 20 at a position between the part of the tire 10 where the strain sensor 1-1 is disposed and the part of the tire 10 where the strain sensor 1-2 is disposed. In this case, in a case where the tire 10 tries to run over the step 20, the positive force in the tension direction acting on the tire 10 from the road surface 30 is released and transitions to the reference level 41. Therefore, in a state in which the strain sensor 1-1 is grounded on the road surface 30, as shown in FIGS. 4C(2) and 4C(3), the sensor signal waveform 40 of the sensor output signal at the step contact position decreases, and its differential value′ becomes a negative value.

Although not shown in the drawing, in a case where the part of the tire 10 where the strain sensor 1-1 is disposed contacts the step 20 after being separated from the road surface 30, the negative force in the compression direction acting from the road surface 30 is released and transitions to the reference level 41. Therefore, the sensor signal waveform 40 of the sensor output signal increases, and its differential value′ becomes a positive value. The step is detected using the positive and negative differential values, and an upper limit threshold 64a and a lower limit threshold 65a set by a threshold setting unit 52.

Next, a step detection method by the step detection device 2 of the present embodiment will be described with reference to FIGS. 5, 6, 7, 8, 9, 10A, 10B, and 10C.

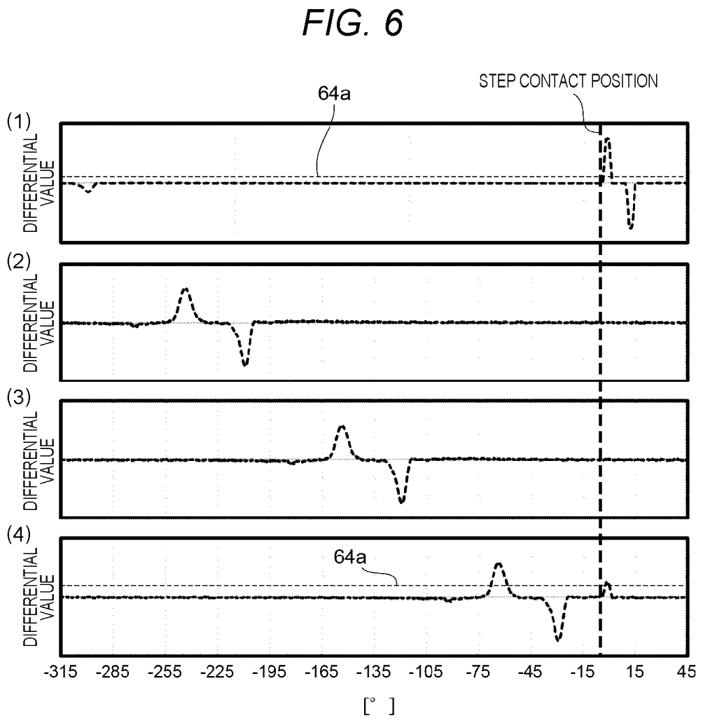

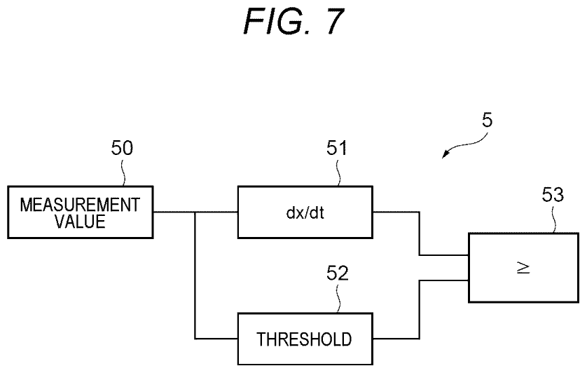

FIG. 5 is a diagram explaining a configuration of the signal processor, FIG. 6 shows graphs showing a differential value of an output signal of each strain sensor with respect to an angular position of the tire, and FIG. 7 is a block diagram explaining a configuration of a threshold determination unit. FIG. 5 shows an example of threshold determination using a differential value of an output signal at a position where the tire 10 contacts the step 20.

The signal processor 4 has a configuration implemented by an internal function of the control unit 101, and processes detection signals of the plurality of strain sensors 1-1 to 1-4. The signal processor 4 detects a step based on detection signals of two or more adjacent strain sensors 1 among the plurality of strain sensors 1-1 to 1-4. As shown in FIG. 5, the signal processor 4 includes a threshold determination unit 5 and a step determination unit 6.

As shown in FIG. 7, the threshold determination unit 5 uses a measurement value calculated by a measurement value calculation unit 50 to obtain a differential value from a differential value calculation unit 51. The measurement value calculation unit 50 obtains measurement values by performing smoothing processing on the detection signals (raw measurement values) detected by the strain sensors 1. The differential value calculation unit 51 obtains differential values by time-differentiating the measurement values.

A threshold comparison unit 53 compares a threshold set in advance by the threshold setting unit 52 with the differential value obtained by the differential value calculation unit 51, and determines whether the differential value exceeds the threshold. In the threshold setting unit 52, an upper limit threshold on the positive side and a lower limit threshold on the negative side are set. In the threshold comparison unit 53, in a case where the differential value is outside a threshold range between the threshold on the positive side and the threshold on the negative side, the differential value is determined to exceed the threshold and a logical value of ‘1’ is indicated, and in other cases, the differential value is determined not to exceed the threshold and a logical value of ‘0’ is indicated.

Next, the step determination unit 6 shown in FIG. 5 determines whether a step has been detected. The step determination unit 6 determines that a step has been detected in a case where differential values of measurement values of two or more adjacent strain sensors 1 among differential values of measurement values of the plurality of strain sensors 1 exceed a threshold. The step determination unit 6 obtains the logical product (AND) of two or more adjacent strain sensors 1 (for example, the strain sensors 1-1 and 1-4) for all the strain sensors mounted on the tire 10. In the present embodiment, since the four strain sensors 1 are provided, logical products (AND) of the strain sensors 1-1 and 1-2, 1-2 and 1-3, 1-3 and 1-4, and 1-4 and 1-1 are obtained. The logical determination is performed by taking the logical sum (OR) of the obtained logical values.

The step determination unit 6 determines that there is a step in a case where the logical value is ‘1’ is obtained as a result of the logical determination. The differential value of the strain sensor 1-1 shown in FIG. 6(1) and the differential value of the strain sensor 1-4 shown in FIG. 6(4) are not smaller than the threshold at the rotation angle of the tire at the step contact position, and at such a position, the logical values of the strain sensors 1-4 and 1-1 are all ‘1.’ Therefore, the logical value of the logical product (AND) thereof is also ‘1,’ and the logical sum (OR) of the logical values is also ‘1,’ indicating the step. That is, it is determined that the step has been detected.

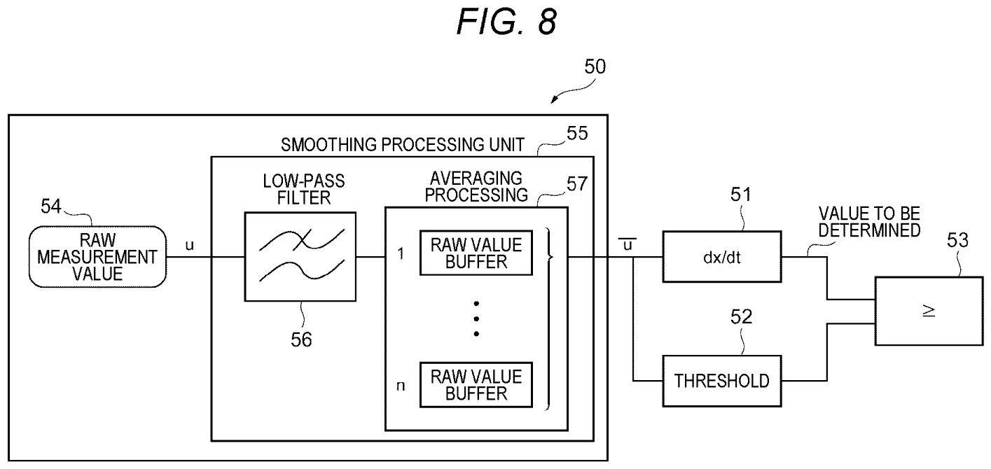

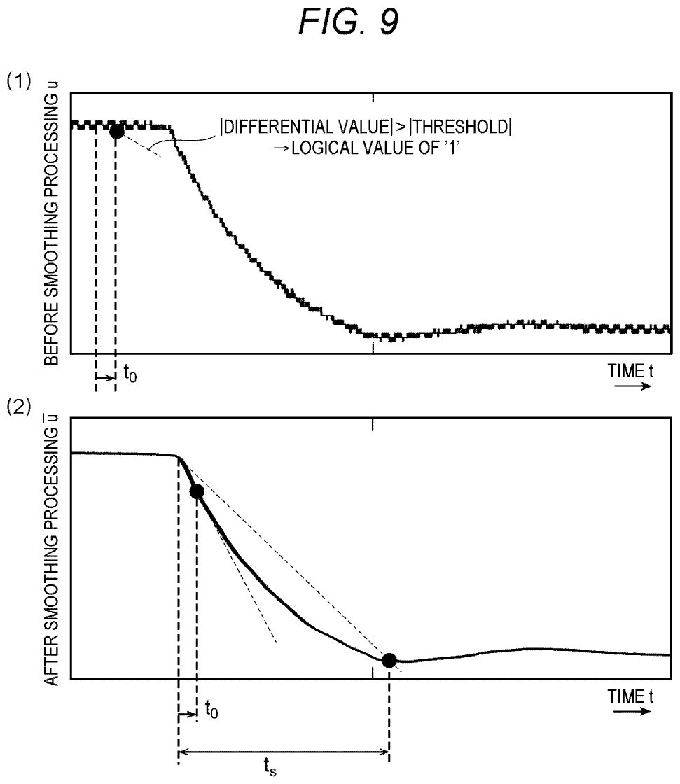

FIG. 8 is a block diagram associated with threshold determination, showing an example of an operation for an erroneous step detection prevention method. FIG. 9 shows determination graphs showing an example of an operation of the step detection device 2, in which FIG. 9(1) is a graph showing a change in the differential value before smoothing processing, and FIG. 9(2) is a graph showing a change in the differential value after smoothing processing. In the measurement value calculation unit 50, raw measurement values 54 measured by the strain sensors 1 are subjected to predetermined smoothing processing by a smoothing processing unit 55, and then supplied to the differential value calculation unit 51. The smoothing processing unit 55 has a low-pass filter 56 that removes noise of the raw measurement value 54, and an averaging processing unit 57 that averages n raw value buffers.

As shown in FIG. 9(1), without the smoothing processing of the measurement value calculation unit 50, for example, in a case where the differential value is calculated from a prominent value, the differential value exceeds the threshold, and thus a logical value of ‘1’ is indicated, which may cause unintended erroneous determination. In the present embodiment, prominent values and values deviating from other values can be removed by performing the smoothing processing with the measurement value calculation unit 50. Therefore, as shown in FIG. 9(2), the step can be determined from a differential value at t0 before waiting for a time ts until the changes in the detection signals of the strain sensors 1 are saturated. Accordingly, the determination is made immediately after the tire 10 contacts the step 20, and the step can be real-time detected before the tire runs over the step 20.

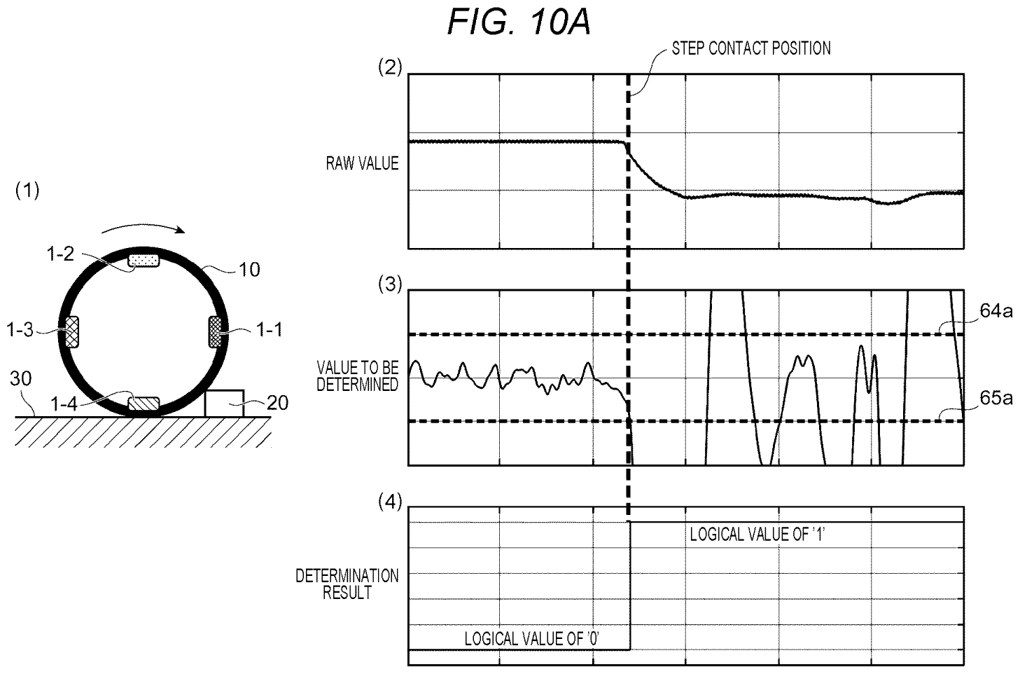

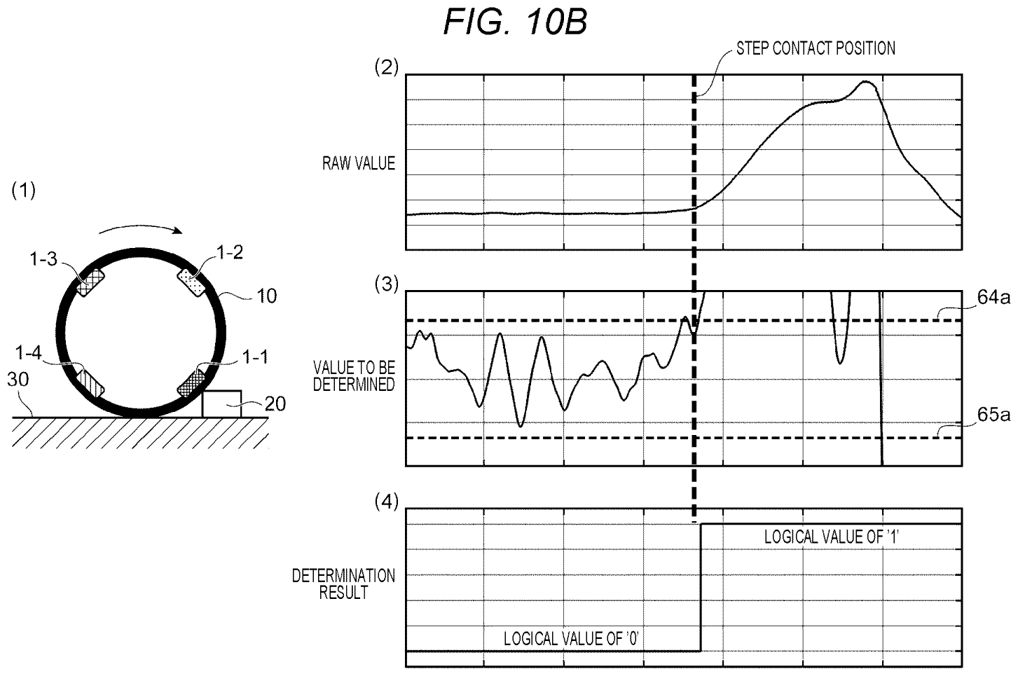

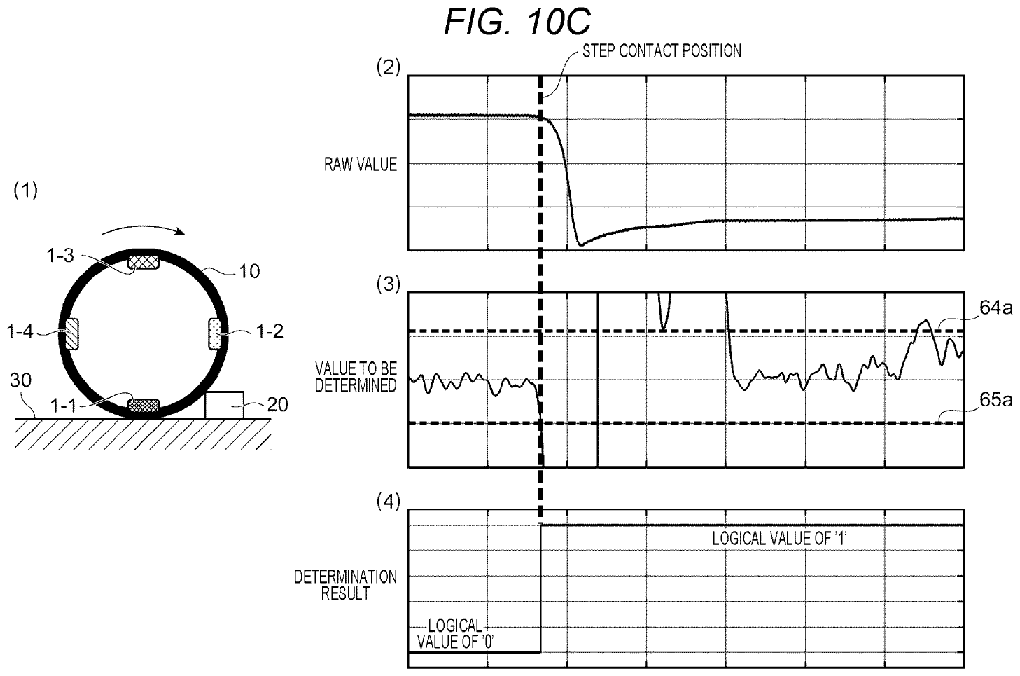

In the present embodiment, as shown in FIGS. 10A, 10B, and 10C, model simulation was performed, and it was confirmed that the step can be correctly determined within a sensor's road surface detection range (3 points in the representative examples). FIG. 10A shows a schematic diagram showing a state in which the tire 10 contacts the step 20 at a position where the strain sensor 1-1 is positioned above the step 20, and schematic diagrams showing an example of an output signal of the strain sensor 1-1 and a determination result in that state. FIG. 10B shows a schematic diagram showing a state in which the part of the tire 10 where the strain sensor 1-1 is disposed contacts the step, and schematic diagrams showing an example of an output signal of the strain sensor 1-1 and a determination result in that state. FIG. 10C shows a schematic diagram showing a state in which the tire 10 is grounded on the road surface at a position where the strain sensor 1-1 is positioned below the step 20, and schematic diagrams showing an example of an output signal of the strain sensor 1-1 and a determination result in that state. In any case, the logical value changes from ‘0’ to ‘1’ at the step contact position, and it can be understood that the step can be correctly detected.

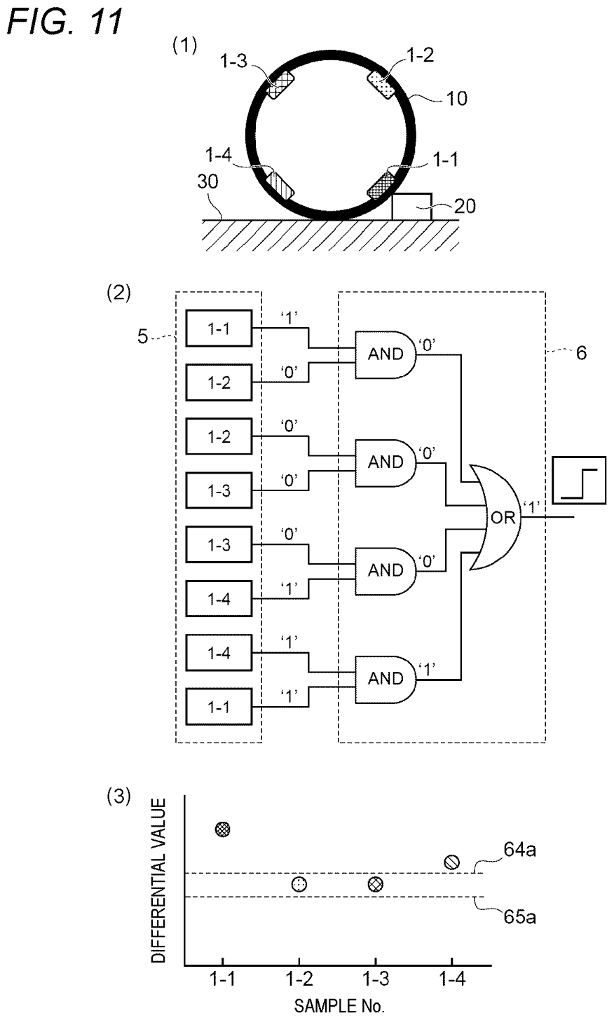

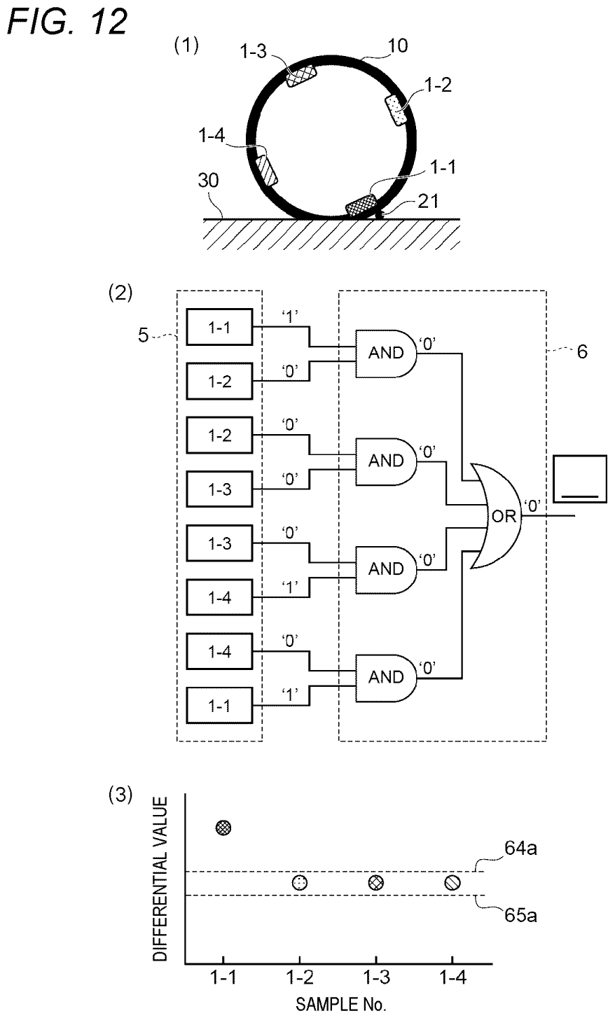

Next, an example of the operation for the erroneous step detection prevention method will be described with reference to FIGS. 11 and 12.

FIG. 11 shows a state in which the tire contacts the step, operation contents of the determination circuit in the above state, and a determination graph of the differential values of the strain sensors. FIG. 12 shows a state in which the tire treads on a small object such as gravel, operation contents of the determination circuit in the above state, and a determination graph of the differential values of the strain sensors. In the present embodiment, as shown in FIG. 11(1), the step 20 is assumed to be an object having a height of about 100 mm from the road surface 30, such as a wheel stopper. As shown in FIG. 11(3), the differential values of the adjacent strain sensors 1-1 and 1-4 are larger than an upper limit threshold 64a, and as shown in FIG. 11(2), the result of the logical product (AND) is a logical value of ‘1.’

For example, as shown in FIG. 12(1), in a case where the tire contacts an object having a height of about 5 to 40 mm such as gravel 21 during traveling, the contact height between the tire 10 and the gravel 21 is low, and the detection range is also narrower than in a case of contact with the road surface 30 or the step 20. Therefore, the result of the logical product (AND) of two or more adjacent strain sensors 1 (for example, the strain sensors 1-1 and 1-4) is a logical value ‘0.’

In addition, the result of the logical product (AND) of any two adjacent strain sensors in all the mounted strain sensors 1 is also a logical value ‘0.’ In logical summing (OR) of the logical values finally obtained, the result of the logical determination is also a logical value of ‘0.’ Therefore, the gravel 21 is not erroneously detected as the step and erroneous step detection can be prevented. In this way, by using the logical product (AND) of two adjacent sensors, it is possible to distinguish and determine the gravel 21 and the step 20.

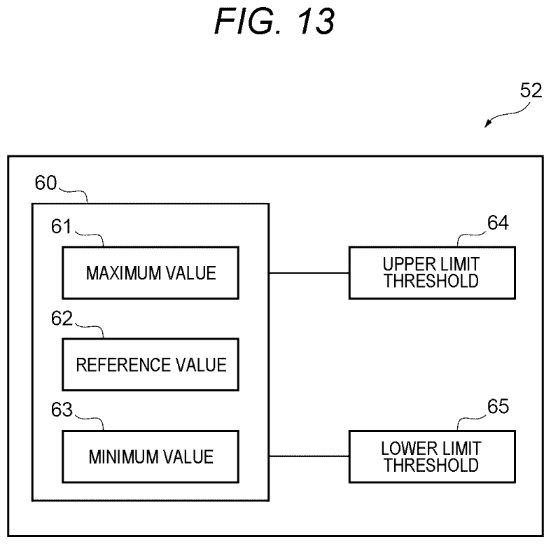

FIG. 13 is a block diagram showing an example of a method of setting the threshold used for determination of the step.

For example, in a case where the absolute value of a difference from the reference level 41 is different between the peak value 42 of the positive level and the peak value 43 of the negative level as shown in FIG. 3, when the threshold is fixed to the same value between the positive and the negative, no change may be detected in the peak value 43 of the negative level having a small change per unit time. Therefore, in the present embodiment, with the following configuration of the threshold setting unit 52, a change is detected in response to both positive and negative thresholds.

The threshold setting unit 52 has a measurement value holding unit 60, an upper limit threshold setting unit 64, and a lower limit threshold setting unit 65. For example, the measurement value holding unit 60 holds, as measurement values of the strain sensors 1, a maximum value 61, a reference value 62, and a minimum value 63 during a certain period. The maximum value 61, the reference value 62, and the minimum value 63 are the maximum peak value of the positive level, the value of the reference level 41, and the minimum peak value of the negative level during a certain period. The upper limit threshold setting unit 64 and the lower limit threshold setting unit 65 set the upper limit threshold 64a and the lower limit threshold 65a based on the maximum value 61, the reference value 62, and the minimum value 63 held in the measurement value holding unit 60.

The upper limit threshold setting unit 64 sets the upper limit threshold 64a based on the maximum value 61 and the reference value 62 held in the measurement value holding unit 60, and sets the upper limit threshold 64a with, for example, a value obtained by multiplying a time differential value of the maximum value 61 and the reference value 62 by a certain gain. The upper limit threshold setting unit 64 determines the upper limit threshold 64a to be equal to or larger than a value smaller than a differential (positive slope) between the reference value 62 and the maximum value 61. The lower limit threshold setting unit 65 sets the lower limit threshold 65a based on the reference value 62 and the minimum value 63 held in the measurement value holding unit 60, and sets the lower limit threshold 65a with, for example, a value obtained by multiplying a time differential value of the reference value 62 and the minimum value 63 by a certain gain. The lower limit threshold setting unit 65 determines the lower limit threshold 65a to be smaller than a value larger than a differential (negative slope) between the reference value 62 and the minimum value 63.

Then, the threshold comparison unit 53 logically determines that the differential value obtained by the differential value calculation unit 51 is equal to or larger than the upper limit threshold 64a or smaller than the lower limit threshold 65a, and it is thus possible to detect a change in any of the peak value 42 of the positive level and the peak value 43 of the negative level.

The upper limit threshold 64a and the lower limit threshold 65a are preferably set at an initial stage, but may be updated at appropriate times by learning the traveling state. In this case, for example, it is also possible to detect a step by distinguishing between a step that the driver wants to pass over and a step that the driver does not want to pass over, based on the setting of the thresholds.

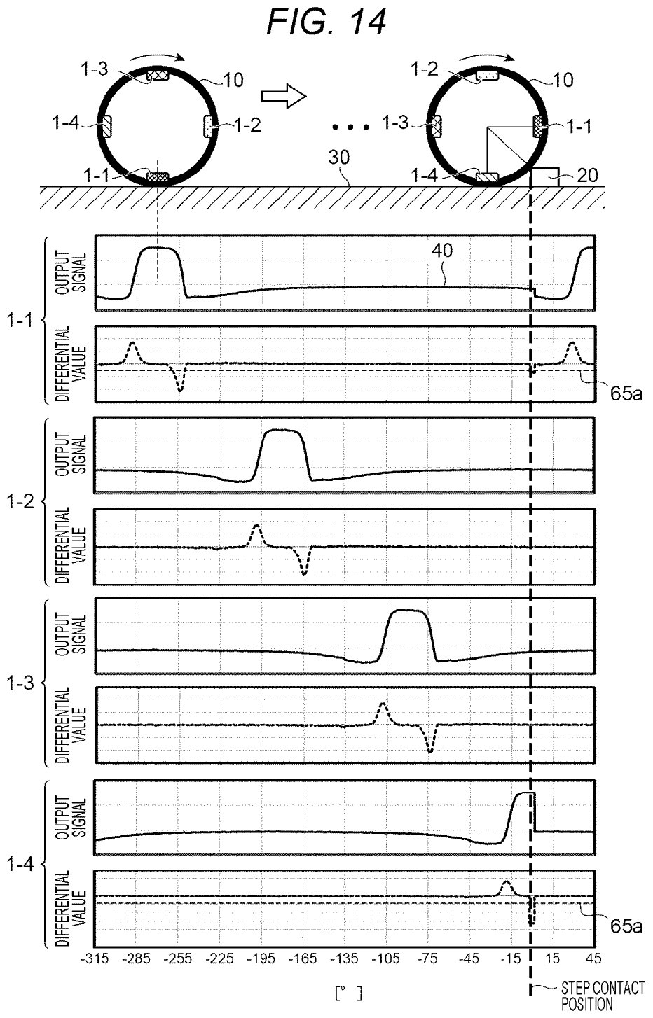

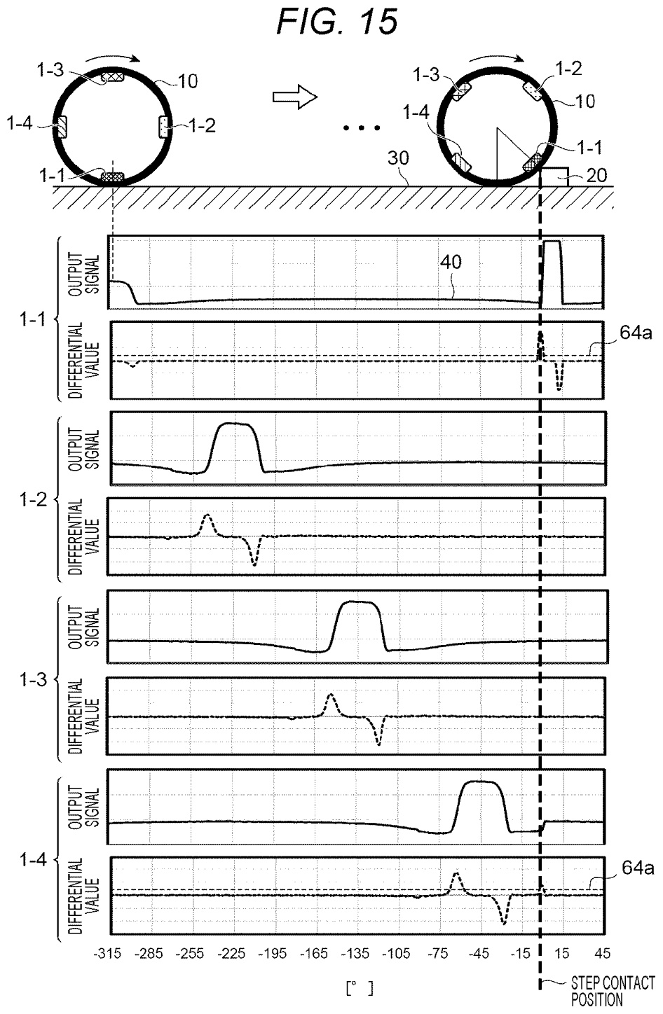

Next, an example of an operation of the step detection device 2 at the position of each strain sensor will be described with reference to FIGS. 14 and 15.

FIG. 14 shows time charts showing an example of changes in the output signal and the differential value when the tire contacts the step as in the state shown in FIG. 4A(1), and FIG. 15 shows time charts showing an example of changes in the output signal and the differential value when the tire contacts the step as in the state shown in FIG. 4B(1). Here, shown in an example where the four strain sensors 1 are mounted on the tire 10, but the number of the strain sensors 1 is not limited to the above number. A plurality of the strain sensors 1 may be mounted to detect the step 20.

The example shown in FIG. 14 shows the sensor signal waveforms 40 and the time differential waveforms of the strain sensors 1 in the state shown in FIG. 4A(1), that is, until the tire 10 rolls and moves on the road surface 30, the part where the strain sensor 1-1 is disposed is positioned above the step 20, and the tire 10 contacts the step 20.

When the tire 10 contacts the step 20 and the force acting from the step 20 deforms the tire 10, the strain sensor 1-1 receives the force in the compression direction, leading to a change to a more negative side than the reference level 41 (see FIG. 3). Therefore, the differential value of the sensor signal waveform 40 at the step contact position is a negative value and is less than the lower limit threshold 65a. The strain sensors 1-2 and 1-3 receive no force acting from the outside and thus indicate the reference level 41, and no change is shown in the differential value at the step contact position.

In the strain sensor 1-4, in a case where the tire 10 tries to run over the step 20, the positive force in the tension direction acting from the road surface 30 is released and transitions to the reference level 41, whereby the differential value of the sensor signal waveform 40 at the step contact position is a negative value and is less than the lower limit threshold 65a. Therefore, in the positional relationship between the strain sensors 1-1 to 1-4, in a case where the tire 10 contacts the step 20, ‘1’ is indicated in the threshold determination unit 5 for each of the strain sensors 1-1 and 1-4, the result of the logic determination in the step determination unit 6 is ‘1,’ and thus it is possible to perform the step detection for real-time determining the step 20 at the step ground position.

Next, the example shown in FIG. 15 shows the sensor signal waveforms 40 and the time differential waveforms of the strain sensors 1 in the state shown in FIG. 4B(1), that is, until the tire 10 rolls and moves on the road surface 30 and the part where the strain sensor 1-1 is disposed contacts the step 20.

When the tire 10 contacts the step 20 and the force acting from the step 20 deforms the tire 10, the strain sensor 1-1 receives the force in the tension direction, leading to a change to a more positive side than the reference level 41 (see FIG. 3). Therefore, the differential value of the sensor signal waveform 40 at the step contact position is a positive value and is equal to or more than the upper limit threshold 64a. The strain sensors 1-2 and 1-3 receive no force acting from the outside and thus indicate the reference level 41, and no change is shown in the differential value at the step contact position.

In the strain sensor 1-4, in a case where the part of the tire 10 where the strain sensor 1-1 is disposed contacts the step 20 after being separated from the road surface 30, the negative force in the compression direction acting from the road surface 30 is released and transitions to the reference level 41. Therefore, the differential value of the sensor signal waveform 40 is a positive value. Therefore, in this case as well, in a case where the tire 10 contacts the step 20, ‘1’ is indicated in the threshold determination unit 5 for each of the strain sensors 1-1 and 1-4, the result of the logic determination in the step determination unit 6 is ‘1,’ and thus it is possible to perform the step detection for real-time determining the step 20 at the step ground position.

Note that the positional relationship in FIG. 4C(1) is the same as that in a case where FIG. 4A(1) is rotated by 90°, and thus illustration and description of step detection are omitted.

As described above, it is possible to real-time detect a step even in a case where the tire 10 contacts the step 20 in any positional relationship between the strain sensors 1.

Next, an example of the strain sensor 1 of the present embodiment will be described with reference to FIGS. 16 and 17.

The strain sensor 1 of the present embodiment is formed of a strain detection module 3.

FIG. 16 is a plan view of the strain detection module 3, and FIG. 17 is a cross-sectional view along line AA in FIG. 16. As shown in FIG. 16, the strain detection module 3 includes a strain detection element 3a, a base member 3b, a sealing part 3c, and an electric wire part 3d. The strain detection element 3a is a semiconductor that outputs a strain amount according to a change in the electric resistance, and is, for example, a strain sensor chip combined into one chip with a control circuit that performs strain detection processing.

The strain sensor chip is an IC chip manufactured by semiconductor processing, and is, for example, a rectangular MOSFET sensor chip having a size of about 5 mm×5 mm. In addition, the strain sensor chip is formed of, for example, a semiconductor formed by CMOS processing and a microelectromechanical system (MEMS). In a case where the strain sensor chip is large, there is a risk of damage when the tire 10 runs over a foreign object. Therefore, the strain sensor chip is preferably smaller than 5 mm×5 mm. The strain detection element 3a is not limited to the strain sensor chip, and for example, a strain gauge may be used.

The base member 3b is a member that fixes the strain detection element 3a to the tire inner circumferential surface, and is, for example, a metal thin plate in which a coefficient of linear expansion is close to that of a semiconductor material (Si or the like) forming the strain detection element 3a. As a metal in which a coefficient of linear expansion is close to that of a semiconductor material (Si or the like), it is possible to use, for example, 42 alloy (42 alloy: alloy in which nickel is blended with iron) having a coefficient of linear expansion of about 5 ppm/° C., that is approximately 1 ppm/° C. different from a coefficient of linear expansion of about 4 ppm/° C. of silicon (Si).

By using, as the material of the base member 3b, a metal having a coefficient of linear expansion close to that of a semiconductor material, it is possible to improve the strain detection accuracy of the strain detection element 3a.

In addition, the base member 3b is not limited to the above metal. For example, a metal (stainless steel, aluminum, copper, an iron-based alloy, or a base metal plated with gold, nickel, tin, or the like) having corrosion resistance to a sulfur gas generated from the tire may be used.

The base member 3b is a rectangular thin plate in order to be easily held by a holding member 7 and to accurately transmit the tire's strain to the strain detection element 3a. In addition, an end part of the base member 3b in a +Z direction (front side) is formed in an arc shape as shown in FIG. 11. The shape of the base member 3b is not limited to the above shape, and may be a circle, an ellipse, or another polygon. The strain detection element 3a is fixed to a surface (+Z-side surface) of the base member 3b with an adhesive such as an epoxy-based adhesive having high hardness.

The sealing part 3c is a resin such as an epoxy resin applied to the surface of the base member 3b from above the strain detection element 3a and a bonding wire (not shown) that electrically connects the strain detection element 3a and the electric wire part 3d. The strain detection element 3a and the bonding wire are sealed by the sealing part 3c and protected from the external environment. The sealing part 3c is not limited to an epoxy resin, and other resins such as a urethane resin and a silicone resin may be used.

The electric wire part 3d is an electric wire that electrically connects the strain detection element 3a and a circuit, and is, for example, a flexible printed circuit (FPC). In addition, the strain detection element 3a is a semiconductor that outputs a strain amount according to a change in the resistance, and is, for example, a semiconductor strain sensor. Therefore, the measurement can be performed with higher sensitivity (for example, about 25,000 times) and lower power consumption (for example, about 1/1,000) compared to a case of a strain gauge.

The control unit 101 of the present embodiment includes a vehicle controller that acquires a result of the step detection by the step detection device 2 and performs accelerator/brake control of the vehicle. For example, when the tire contacts a vehicle stop block in a parking space, the step detection device 2 detects the vehicle stop block as a step. Therefore, in order to prevent the vehicle from passing over the vehicle stop block, the vehicle controller can control the vehicle so that a throttle valve of the engine is closed to reduce the driving force and the brake is operated to stop the vehicle by the braking force. Therefore, it is possible to prevent an occupant from feeling uneasy by suppressing a sudden change in the vehicle's behavior.

In addition, in a case where the vehicle passes over a step and enters a place one step higher, the vehicle can also be controlled so that, when the step is detected, the throttle valve of the engine is opened to increase the driving force, allowing the tire 10 to run over the step 20, and the braking force is applied at a time point when the tire 10 is laid on the step 20 to prevent the vehicle from advancing too far. Therefore, it is possible to safely pass over or run over the step with a smooth operation without discomfort.

According to the step detection device 2 of the present embodiment described above, it is possible to accurately detect a step in a case where the tire runs over the step. Accordingly, it is possible to control a driving system such as an accelerator and a brake based on the accurate step determination, and it is possible to cause the vehicle to safely run over or pass over the step with a smooth operation without discomfort. In addition, since the step detection is performed based on the output signals of the strain sensors 1 mounted on the tire inner circumferential surface, the step can be detected without being affected by weather, environmental conditions, and the like.

While the embodiments of the present invention have been described in detail above, the present invention is not limited to the above embodiments, and various design changes can be made without departing from the spirit of the present invention described in the claims. For example, the above-described embodiments have been described in detail in order to describe the present invention in an easy-to-understand manner, and are not necessarily limited to those having all the configurations described. In addition, a part of the configuration of one embodiment can be replaced with the configuration of another embodiment, and the configuration of another embodiment can be added to the configuration of one embodiment. In addition, a part of the configuration of each embodiment can be added, deleted, or replaced with another configuration.

### REFERENCE SIGNS LIST

1 strain sensor
2 step detection device
3 strain detection module
3a strain detection element
3b base member
3c sealing part
3d electric wire part
5 threshold determination unit
6 step determination unit
10 tire
20 step
21 gravel
30 road surface
40 sensor signal waveform
41 reference level
42 peak value of positive level
43 peak value of negative level
50 measurement value calculation unit
51 differential value calculation unit
52 threshold setting unit
53 threshold comparison unit
60 measurement value holding unit
61 maximum value
62 reference value
63 minimum value
64a upper limit threshold
65a lower limit threshold
100 vehicle
101 control unit
102 receiver

1. A step detection device that detects a step in a case where a tire of a vehicle runs over the step, the step detection device comprising:
a plurality of strain detection elements disposed on a tire inner circumferential surface of the tire at predetermined intervals in a circumferential direction of the tire; and
a signal processor that processes detection signals of the plurality of strain detection elements,
wherein the signal processor detects the step based on detection signals of two or more adjacent strain detection elements among the plurality of strain detection elements.

2. The step detection device according to claim 1,
wherein the signal processor has
a threshold determination unit that calculates a differential value of a measurement value of each of the plurality of strain detection elements, compares the differential values of the measurement values of the plurality of strain detection elements with a preset threshold, and determines whether the differential values of the measurement values of the plurality of strain detection elements exceed the threshold; and
a step determination unit that determines that the step has been detected in a case where differential values of measurement values of two or more adjacent strain detection elements among the differential values of the measurement values of the plurality of strain detection elements exceed the threshold.

3. The step detection device according to claim 2,
wherein the threshold determination unit has
a differential value calculation unit that obtains the measurement values by performing smoothing processing on the detection signals of the plurality of strain detection elements and calculates the differential values by time-differentiating the measurement values;
a threshold setting unit that sets an upper limit threshold and a lower limit threshold; and
a threshold comparison unit that determines that the differential value exceeds the threshold in a case where the differential value is outside a threshold range between the upper limit threshold and the lower limit threshold.

4. The step detection device according to claim 3,
wherein the threshold setting unit has
a measurement value holding unit that holds a reference value, a maximum value, and a minimum value of the measurement value during a certain period;
an upper limit threshold setting unit that sets the upper limit threshold based on the reference value and the maximum value of the measurement value; and
a lower limit threshold setting unit that sets the lower limit threshold based on the reference value and the minimum value of the measurement value.

5. The step detection device according to claim 4,
wherein the upper limit threshold setting unit determines the upper limit threshold to be equal to or larger than a value smaller than a differential between the reference value and the maximum value of the measurement value, and
the lower limit threshold setting unit determines the lower limit threshold to be smaller than a value larger than a differential between the reference value and the minimum value of the measurement value.

6. The step detection device according to claim 1,
wherein the strain detection element is a semiconductor that outputs a strain amount according to a change in electric resistance.

7. A vehicle controller that acquires a determination result of step detection from the step detection device according to claim 1; and
controls an accelerator or a brake of a vehicle based on the determination result.
